(19) United States
(12) Patent Application Publication
(10) Pub. No.: US 2009/0327031 A1
(43) Pub. Date: Dec. 31, 2009

(54) RENT-TO-OWN MEDIA

(75) Inventor: Kamal Jain, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,457

(22) Filed: Jun. 26, 2008

(51) Int. Cl. G06Q 30/00; G06Q 10/00; G06F 21/00

(52) U.S. Cl. 705/10; 705/30; 705/1; 726/27

(57) ABSTRACT

The described implementations relate to rent-to-own media. One technique provides digital rights restricted media to a consumer on a rent-to-own basis. The technique also removes the digital rights restrictions from the media upon completion of the rent-to-own basis.

### BACKGROUND

A consumer who is considering the purchase of a product tends to go through some mental calculation to determine whether to buy the product. Often this mental calculation involves perceived value and confidence that he/she will be satisfied with the purchase. For instance, in relation to perceived value, the consumer may consider whether his or her value of the product is as great as or greater than the asking price. In relation to confidence, the consumer may wonder whether he/she will actually like the product and also whether he/she will actually use the product enough to justify the purchase price. Viewed another way, in hindsight is the consumer satisfied with the purchase or wish they had not made the purchase.

For most products, retailers have learned that they can increase their sales volume by addressing the consumer's confidence calculation. For instance, if the consumer is looking at compact disc (CD) players, many retailers openly convey a no-questions return policy (i.e., “go ahead and buy it and if you don't like it or don't use it you can bring it back”). Studies show that consumers are much more likely to purchase the product in such a scenario because the no-questions return policy effectively addresses their confidence calculation. In these scenarios the consumers are more likely to go ahead and purchase the product and in most cases consumers are satisfied with the purchase and do not end up returning the product. Thus, for the retailer the potential costs of the no-questions return policy are outweighed by the increased sales.

One product area that has generally been excluded from the no questions return policy is digital media, such as music and videos. For instance, if the consumer is shopping for music CDs for the new CD player then a different return policy is applied by the retailer. One reason for this differentiation can be digital rights management concerns. For instance, it is easy to make a copy of a CD.

Given the digital rights management concerns and the ease of making copies of CDs, the consumer may be allowed to return a purchased CD if the packaging remains unopened. If the CD, upon opening, is scratched or otherwise defective the retailer may give the consumer a different copy of the same CD, but an opened CD cannot be returned for cash or credit. This return policy is designed to prevent the consumer from buying the CD, copying it and then returning it. Thus, the consumer is returned to the initial consideration of wondering whether they will be satisfied with the purchase. What if they don't like the music or rarely use it? In this scenario fewer CDs are sold than would be sold under no-questions asked return policy.

Online music stores have carried on the bricks and mortar music policy, but generally at a song level rather than at a CD level. The online music stores sell individual songs to consumers at a fixed price such as $1. The price may seem small for an individual song, but given that a consumer may want hundreds or thousands of songs, the consumer still has to make the same calculation; will I be satisfied with the purchase? So, the consumer may again be considering whether they will actually like the songs and/or actually have the time to listen to the songs. As with the bricks and mortar CD scenario, this consideration can reduce sales by making the consumer more reluctant to make the purchase because of concerns that they may not be satisfied with their purchase. The present concepts address these and other scenarios.

### SUMMARY

The described implementations relate to rent-to-own media. One technique provides digital rights restricted media to a consumer on a rent-to-own basis. The technique also removes the digital rights restrictions from the media upon completion of the rent-to-own basis.

Another implementation is manifested as a technique that offers a song to a consumer for a trial period. The technique also determines consumer satisfaction with the song based upon consumer usage of the song during the trial period. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 illustrates an exemplary media rent-to-own system in accordance with some implementations of the present concepts.

FIG. 2 shows timelines that can illustrate rent-to-own media concepts in accordance with some implementations of the present concepts.

FIG. 3 is a flowchart of an exemplary rent-to-own media technique in accordance with some implementations of the present concepts.

FIG. 4 illustrates an exemplary media rent-to-own system in accordance with some implementations of the present concepts.

### DETAILED DESCRIPTION

### Overview

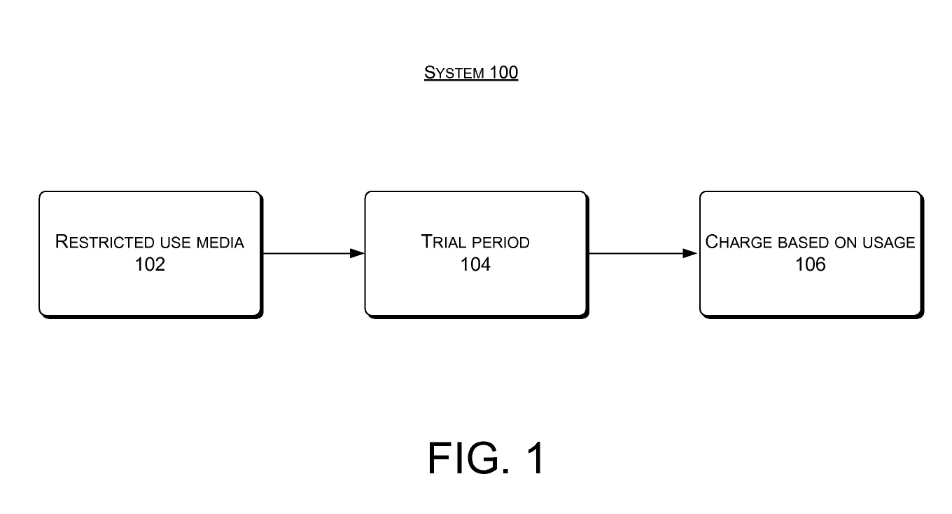

This patent application pertains to rent-to-own media. For discussion purposes consider introductory FIG. 1 which shows one rent-to-own media system or technique 100. At 102 restricted-use media can be supplied to the user or consumer. For instance, the consumer can select the restricted-use media from a web-site and the selected media can then be downloaded to the consumer's media player. Assume for sake of brevity that in this case, restricted-use media means that the media can only be played on the media player upon which it was downloaded.

The consumer's usage of the restricted-use media can be monitored during a rental or trial period 104. At the end of the trial period the consumer can be charged based on usage 106. In essence, the consumer's usage during the trial period can effectively convey the consumer's satisfaction with the restricted-use media and the charges associated with the restricted-use media. In this case, the usage during the trial period can be compared to a predefined usage threshold (hereinafter, “threshold”). If the usage satisfies (i.e., equals) the threshold, then the consumer is charged a purchase price of the media and the use-restriction can be removed from the media. If the usage is under the threshold, then the consumer is charged a reduced (or zero) amount and the media is deleted from the consumer's media player. In summary, system 100 can allow the consumer to purchase the media without worrying that he/she will be stuck paying for the media if they don't use it or don't like it.

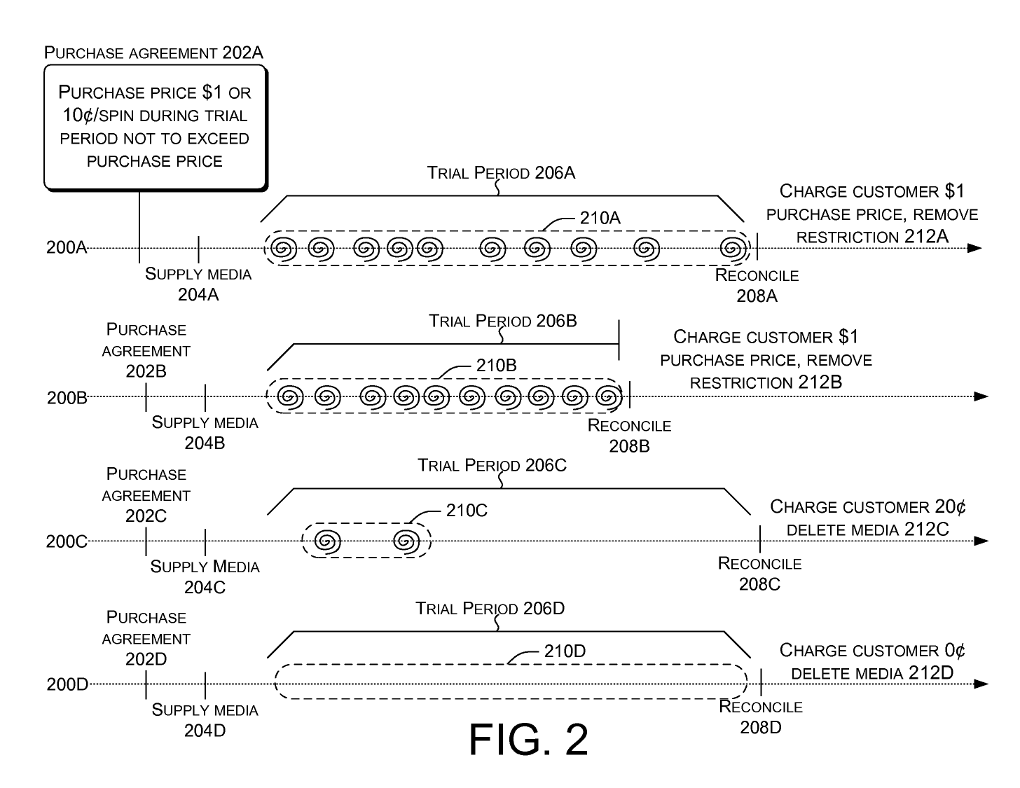

FIG. 2 provides exemplary timelines 200 that help to explain rent-to-own concepts in accordance with some implementations. In this case, four exemplary timelines are designated 200A, 200B, 200C, and 200D and throughout this discussion designators relating to individual timelines share the same alphabetic suffix.

Assume for purposes of explanation that FIG. 2 relates to a single media in the form of a song and that usage in relation to the song is termed a spin. A spin is where the consumer plays at least a given substantial amount of the song, such as 30 seconds. So for instance, if the consumer is scanning through their songs and plays a couple seconds of each song while looking for a particular song then that is not considered a spin. If on the other hand, the consumer plays say a minute of the song then that is considered a spin.

In this case, each timeline begins with a purchase agreement 202 for the song between a retailer and the consumer. Assume that all four purchase agreements 202A-202D are identical. The purchase agreement as evidenced at 202A establishes conditions for the rent-to-own media scenario. In this instance, the conditions indicate that the purchase price is $1 and that the consumer will be charged 10¢ per spin during a trial period where the total charge is not to exceed the purchase price. Upon completion of purchase agreement 202, the media is supplied to the consumer at 204 on each timeline 200A-200D.

After the media is supplied, a trial or rental period 206 of a predetermined duration begins. Assume that in this example the trial period is one year. The consumer's song usage (in spins) is reconciled with the purchase agreement 202 at the end of trial period 206. Other trial period lengths can range from less than a day to more than a year.

In relation to timeline 200A, ten spins are indicated generally at 210A with the last spin coinciding with the conclusion of the trial period 206A. In this scenario, the reconciliation 208A shows at 212A that the consumer's 10 spins equals the purchase price (10 spins at 10¢ each=$1). Accordingly, the consumer is charged the $1 purchase price and (upon receipt of the purchase price) the restriction is removed from the song and the consumer owns an unrestricted copy of the song free-and-clear. The underlying rationale for this scenario is that the consumer indicated his/her satisfaction with the purchase by spinning the song many times. Accordingly, there is no need to ask the consumer whether they are satisfied with the purchase; actions speak louder than words.

Timeline 200B is similar to timeline 200A except that in this case, the consumer reaches the threshold number of spins (i.e., 10) at 210B before the conclusion of trial period 206B. In this case, the cost to the consumer is the same as with timeline 200A (i.e., $1). The only difference is that by reconciling as soon as the consumer reaches 10 spins the restriction can be removed from the song at an earlier point in time. Accordingly, the consumer would, for instance, be able to copy the song to another one of their media players prior to having such a capability in timeline 200A.

Another variation on this theme would allow the consumer to pay for the remaining spins at any point in the trial period so that they get the song free and clear. For instance, assume that the consumer buys the song and plays it several times that day. The consumer may decide that they like the song so much that just want to pay the remaining balance so that they can remove the restrictions without having to go through the exercise of spinning the threshold number of times. For example, maybe they want to make a copy of the song before they leave for a trip and don't have time to keep spinning the song.

On timeline 200C the consumer plays only two media spins at 210C during trial period 206C. Assume for instance, that on two different occasions the consumer listened to the song, but did not really like the song enough to play it further times. In this case, when the usage is reconciled at 208C with purchase agreement 202C the consumer is only charged twenty cents for the two spins and the media is deleted from the media player at 212C. Accordingly, since the consumer did not use the media enough to purchase the media outright the consumer was charged on an actual use (i.e., rental) basis instead.

On timeline 200D the consumer does not make any media spins (as indicated by empty box 210D) during trial period 206D. For instance, it may be that the consumer bought extra music to listen to on a trip and then cancelled the trip and didn't otherwise have time to listen to the music. In this case, the reconciliation 208D does not result in any charges to the consumer and the media is deleted. Some other implementations may charge some type of fee for providing the rent-to-own option to the consumer. For example, the consumer might be charged a minimum amount such as two percent of the purchase price.

There are various ways in which the payment structure can be implemented in relation to FIG. 2. For instance, in some cases the consumer can be charged the full payment price at the time the purchase agreement 202 is executed. In such a case, then the only task during reconciliation of timelines 202A and 202B may be to remove the restriction from the media. In relation to timeline 202C and 202D the reconciliation would result in a partial and complete refund, respectively. In another configuration, the consumer can be billed in a pay as you go manner so that each time the consumer spins the media they are charged for a spin until (or if) the purchase price is reached within the trial period. Regardless of how the payment structure is set up, the amount paid by the consumer can be consistent following the reconciliation.

To summarize, timelines 200A-200D relate to scenarios where the present implementations can allow consumers to purchase media with confidence that they will be satisfied with their purchase or can effectively return the product. Considered from the consumer's perspective, he or she first acquires the music. The consumer can think of this as buying with a no-questions asked return policy or rent-to-own. He/she then has a trial period in which to use the music. At the conclusion of the trial period, the purchase is confirmed or the music is returned with the consumer only paying for the actual consumption or usage. Further, in this case the return process can be handled automatically without any effort on the part of the consumer.

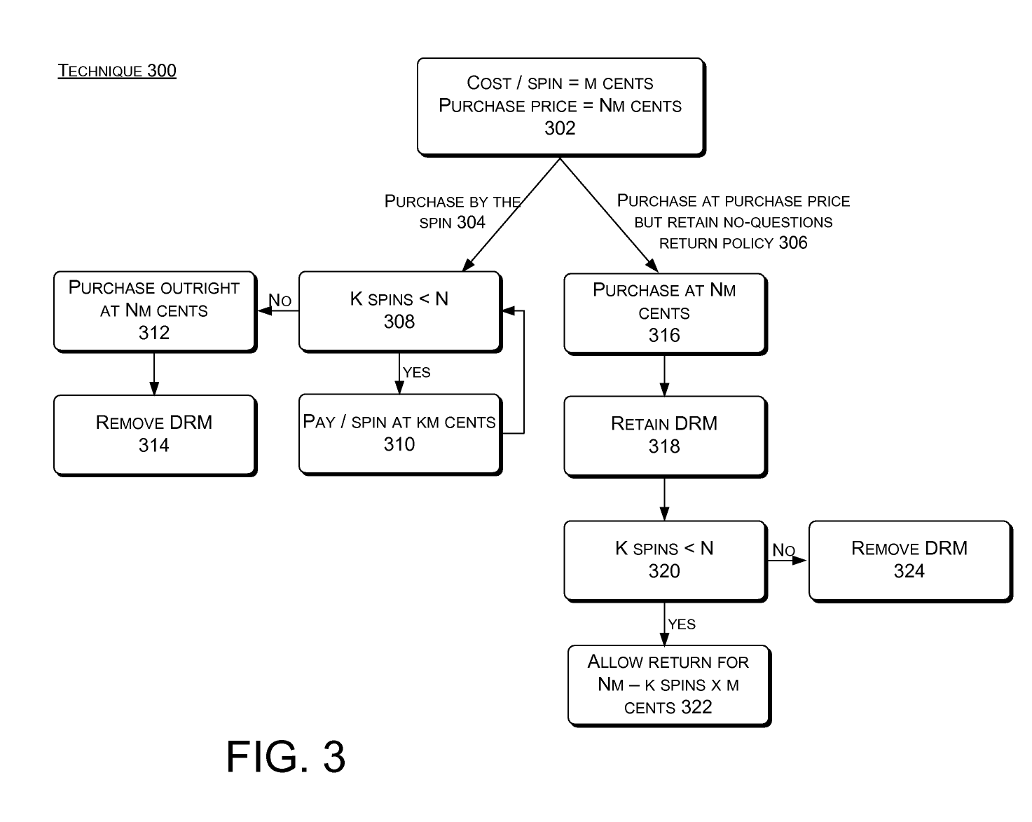

FIG. 3 shows an algorithmic technique 300 that can be utilized by some of the present implementations for pricing songs or other media.

At 302, the technique establishes that cost per spin equals m cents and that the purchase price of the song equals a threshold number of spins N*m cents. The threshold value of N can be selected from a wide range of values that can depend on the duration of the trial period among others. One example was described above in relation to FIG. 2 where the threshold was set at 10. Other implementations can utilize threshold values of five or less or more than a hundred or anywhere in between.

Two variations can be offered to the consumer for purchasing the song. At 304 the consumer can purchase the song by the spin and proceed to block 308.

At 308 the consumer can purchase at the purchase price (i.e., Nm cents), but retain the no-questions asked return policy mentioned above. In an instance where the consumer picks purchase by the spin, then the technique proceeds to block 308.

At block 308 the technique queries whether the number of spins k is less than N. If the number of spins is less than N (e.g., “yes” at 306), then the technique proceeds to block 310. At block 310 the technique determines the payment amount owed by the consumer as k*M cents. At this point the technique returns to block 308.

In an instance where the number of spins is equal to N (e.g., “no” at 308), then the technique proceeds to block 312. At block 312 the technique determines the amount due for outright purchase as Nm cents. If the consumer has paid Nm cents then the technique proceeds to block 314. The skilled artisan should recognize that the consumer may have paid the Nm cent purchase price incrementally. For instance, the technique may have repeatedly gone from block 308 to 310 and back to 308 each time that the consumer spun the song with the consumer being billed each time the technique went through block 310 until finally the number of spins K equaled N and the technique proceeded to block 312. From block 312, the technique proceeds to block 314 where the DRM is removed from the song.

Some implementations of the purchase by the spin technique 304 can utilize non-linear pricing. Non-linear pricing can include a notion of packets. For example, assume that each packet consists of 50 spins. The consumer can get 49 spins for free. On the 50th spin, the consumer can be charged for one packet. The charge to the consumer can remain at one packet until 99 spins. At the 100th spin the consumer can be charged for two packets and so on.

A potential advantage of the non-linear model is especially pronounced in situations where it is difficult to track the consumer's usage. For instance, some media players are not configured to accurately track the number of spins. In that case, 98% of the time that the consumer spins the media the consumer is not charged. Therefore at every spin, the consumer has only a 2% chance of being charged. In an instance where the consumer falls on the 2% side of the equation and is charged, the consumer is losing a small amount. So it is likely that 98% of the time the consumer avoids payment.

Returning to option 306, the consumer can purchase the song at purchase price Nm cents at 316. In such a case, DRM is maintained on the song at 318. The technique then queries at 320 whether the number of spins k is less than N. In an instance where the number of spins k is less than N (e.g., “yes” at 320), then the technique proceeds to block 322 where the consumer is given a return or refund for the difference between the purchase price Nm and the number of spins previously paid for at m cents per spin. Thus, the consumer is refunded the value of any spins paid for but not received. In an alternative case where the number of spins k is equal to N (e.g., “no” at 320), then the technique proceeds to block 324. In this case if the number of spins equals the number of threshold N, then the consumer has fully used the number of spins that were paid for and there is nothing to return so the technique removes the DRM.

While not expressly integrated into technique 300, trial periods were discussed at length in relation to the timelines of FIG. 2. The skilled artisan should recognize that trial periods can be utilized with technique 300. In some cases, the trial period can be utilized to define an end point of technique 300. For instance, in relation to block 308, when the number of spins is less that threshold N, the process goes to block 310 and then loops back to 308. The loop can be interrupted if the number of spins eventually equals the threshold N, so that the technique proceeds to block 312, or the loop can be stopped upon expiration of the trial period. Thus, the processing at block 308 can be thought of as repeating until either the number of spins k equals threshold N (i.e., the consumer has through multiple increments per spin paid the full price) or the trial period expires.

If the trial period expires without the consumer's usage meeting the threshold, then the consumer can be deemed to be unsatisfied with the song. In such a case, the payments can be reconciled for the consumer and the song can be removed from the consumer's media player. Similarly, performance of block 322 may be delayed until the trial period expires so that the refund is calculated only once at the conclusion of the trial period.

The order in which the technique 300 is described is not intended to be construed as a limitation and any number of the described blocks can be combined in any order to implement the technique or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

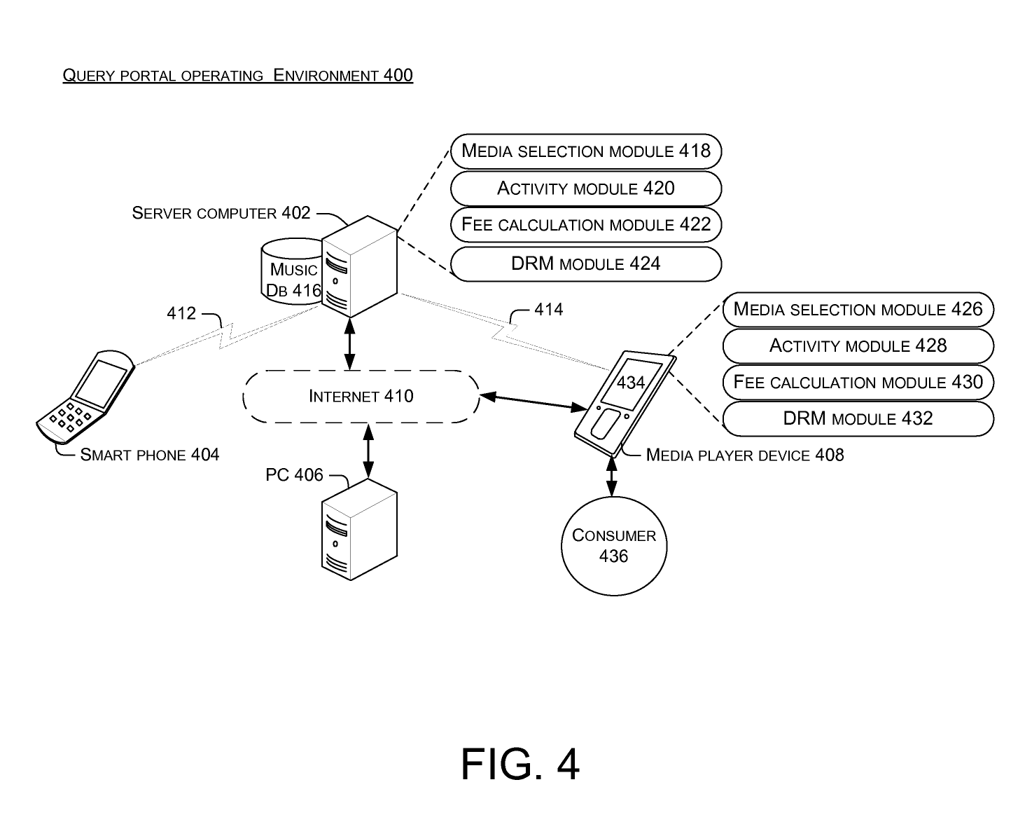

FIG. 4 shows an exemplary operating environment 400 in which the rent-to-own media concepts described above and below can be implemented on various computing devices. This example is directed to media in the form of music, but can be applicable to other forms of media such as video. In this case, the computing devices are manifest as a server computer 402, a smart phone 404, a personal computer 406, and a media player device 408. The computing devices 402-408 can be communicably coupled with one another via the Internet 410 and/or via another communication means such as cellular microwave means 412, 414.

In this configuration, server computer 402 can provide a rent-to-own music service to one or more of computing devices 404-408. Server computer 402 can include a music database (Db) 416, a music selection module 418, an activity module 420, a fee calculation module 422 and a DRM module 424. For the sake of brevity, the rent-to-own music service is explained in relation to media player device 408, but can be applied to either or both smart phone 404 and PC 406 or other computing devices. Media player device 408 has several modules that can work in cooperation with server computing device 402 to provide the rent-to-own music service. In this case, media player device 408 includes a media selection module 426, an activity module 428, a fee calculation module 430, and a DRM module 432.

Media selection module 426 in corporation with media selection module 418 and database 416 can generate a graphical user interface (GUI) 434 from which a consumer 436 can select songs to buy according to the rent-to-own conditions described above in relation to FIGS. 1-3. The rent-to-own conditions, such as those included in purchase agreement 202 (FIG. 2), can be displayed on GUI 434 and agreed to by consumer 436 before the song is downloaded from server computing device 402 to media player device 408. The song can include use restrictions imposed by digital rights management module 424. For instance, one condition may be that the song cannot be copied and that the song can only be played on media player device 408. DRM module 432 can contain a private key or serial number that DRM module 424 associates with the song to restrict its use.

Once the song is resident on the media player device, the consumer can play (i.e., spin) the song. Spins can be tracked on media player device's activity module 428 and/or on the server computing device's activity module 420. Fee calculation modules 422 and/or 430 can calculate fees or payments due based upon the tracked usage. The server computing device's activity module 420 and fee calculation module 422 can perform technique 300 (FIG. 3) to determine the payments and/or to determine if and when the consumer has satisfied the condition to change or remove the DRM restrictions. For instance, once the activity module 420 indicates to the fee calculation module 422 that the consumer has spun the song a threshold number of times the fee calculation module can ascertain whether the consumer has paid the agreed upon purchase price of the purchase agreement. If payment for the purchase price has been received, the fee calculation module can instruct the DRM module to remove the DRM restrictions and/or otherwise change the DRM status of the song. At that point the consumer owns the song free and clear and can, for instance, copy the song to another computing device, such as PC 406.

The efficacy of rent-to-own systems can be dependent upon the configuration of individual computing devices. For instance, if the computing device has a restricted configuration so that it can only obtain and play music from specific sources, then the conditions of the purchase agreement tend to be more easily enforced than upon a computing device that can receive music from different sources in different formats. For example, if the media player device is an Apple brand iPod media player device that can only download songs from Apple's iTunes store, then DRM restrictions are more easily enforced. Similarly, a Microsoft Corp brand Zune media player device may be restricted to downloading from the Zune Marketplace™. In contrast, a PC may be able to obtain music from various sources beyond server computing device 502 thereby making DRM restrictions more difficult to enforce.

### Conclusion

Although techniques, methods, devices, systems, etc., pertaining to rent-to-own media scenarios are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
an activity module configured to track use of media on a media player device; and,
a digital rights management module configured to adjust a digital rights management status applied to the media on the media player device based at least in part on the tracked use, wherein the adiustinci comprises removing digital rights restrictions on the media in an instance when the tracked use satisfies a predefined threshold.

2. The system of claim 1, wherein the activity module is configured to track use as spins of the media on the media player device.

3. The system of claim 2, further comprising a fee module configured to charge for the use on a per spin basis for a predefined number of spins.

4. The system of claim 3, wherein the digital rights management module is configured to change the status of the digital rights management applied to the media after the predetermined number of spins is reached.

5. The system of claim 3, wherein the digital rights management module is configured to remove the digital rights management applied to the media after the predefined number of spins is reached.

6. The system of claim 2, further comprising a fee module configured to charge a flat fee for the media and to refund a portion of the flat fee when the use is below the predefined threshold after a predetermined period of time.

7. The system of claim 6, wherein the flat fee is one dollar, the predefined threshold is twenty spins and the predetermined period of time is one year such that the fee module refunds five cents for each spin under twenty spins at the end of the year.

8. The system of claim 6, wherein the digital rights management module is further configured to remove the media from the media player device when the fee module issues the refund.

9. (canceled)

10. The system of claim 1, wherein the activity module and the digital rights management module reside on the media player device.

11. The system of claim 1, wherein the activity module and the digital rights management module reside on a computing device from which the media was obtained.

12. A computer-readable storage media having instructions stored thereon that when executed by a computing device cause the computing device to perform acts, comprising:
offering a song to a consumer for a trial period;
tracking consumer usage of the song during the trial period;
determining consumer satisfaction with the song by comparing the consumer usage with a predefined usage threshold

13. The computer-readable storage media of claim 12, wherein the offering comprises offering the song for purchase with a no questions return policy during the trial period or a rent-to-own basis during the trial period.

14. (canceled)

15. The computer-readable storage media of claim 12, further comprising charging the consumer on a per use basis until the consumer usage equals the redefined usage threshold.

16. The computer-readable storage media of claim 14, further comprising in an instance where the trial period expires without the consumer usage equaling the predefined usage threshold then charging the consumer for a number of uses during the trial period and deleting the song.

17. The computer-readable storage media of claim 15, wherein the charging comprises refunding the consumer a difference between a purchase price paid by the consumer at the beginning of the trial period and a number of uses during the trial period at a flat rate per use.

18. A computer-readable storage media having instructions stored thereon that when executed by a computing device cause the computing device to perform acts, comprising:
providing digital rights restricted media to a consumer on a rent-to-own basis; and,
removing the digital rights restrictions from the media upon completion of the rent-to-own basis.

19. The computer-readable storage media of claim 18, wherein the providing comprises downloading the digital rights restricted media to a media player belonging to the consumer.

20. The computer-readable storage media of claim 18, wherein the removing comprises removing the digital rights restrictions upon use of the media a predefined threshold number of times within a predetermined period of time.
